(19) United States
(12) Patent Application Publication
(10) Pub. No.: US 2012/0063668 A1
(43) Pub. Date: Mar. 15, 2012

(54) Spatial accuracy assessment of digital mapping imagery

(76) Inventor: GARRY HAIM ZALMANSON, Raanana (IL)

(21) Appl. No.: 12/881,513

(22) Filed: Sep. 14, 2010

(51) Int. Cl. G06K 9/00

(52) U.S. Cl. 382/154

(57) ABSTRACT

The present invention defines a quantitative measure for expressing the spatial (geometric) accuracy of a single optical geo-referenced image. Further, a quality control (QC) method for assessing that measure is developed. The assessment is done on individual images (not stereo models), namely, an image of interest is compared with automatically selected image from a geo-referenced image database of known spatial accuracy. The selection is based on the developed selection criterion entitled “generalized proximity criterion” (GPC). The assessment is done by computation of spatial dissimilarity between N pairs of line-of-sight rays emanating from conjugate pixels on the two images. This innovation is sought to be employed in any optical system (stills, video, push-broom, etc), but its primary application is aimed at validating photogrammetric triangulation blocks that are based on small (<10 MPixels) and medium (<50 MPixels) collection systems of narrow and dynamic field of view together with certifying the respective collection systems.

### BACKGROUND OF THE INVENTION

1. Field of the Invention

The primary usage of the present invention is in the field of photogrammetric mapping from optical aerial imagery with an emphasis on small and medium format and/or field of view (FOV) systems mostly based on general purpose cameras (stills, video). This invention is intended to serve as the central component of geometric accuracy validation¹ analysis for imagery-based spatial IT products. We envision its wide acceptance as part of certification procedures for new digital imagery systems used for geographic information (GI) acquisition. Throughout this invention document we use the terms validation and assessment interchangeably¹

2. Description of the Prior Art

Introduction of digital aerial cameras during the 2000 ISPRS (International Society of Photogrammetry and Remote Sensing) congress in Amsterdam provided the final missing link for turning the photogrammetric mapping production workflows into fully digital. Three flagships of this revolution (Leica ADS40, Intergraph DMC and Vexcel Ultra-Cam-D) with their high-end and large format systems, designed and manufactured specifically for mapping solutions, have dominated the market in the first couple of years of the current millennium. However, in the past few years more and more medium and small-format solutions are reported to be in operation world-wide. These systems are significantly smaller, lighter and cheaper than their high-end counterparts often being comprised of commercial (and sometimes general-purpose) optical, electronic and mechanical elements. But at the same time they claim to have an unprecedented geometric accuracy being comparable to that of their legacy counterparts and achieved by virtue of their proprietary state-of-the art image-processing and computer-vision algorithms. The key factor for these systems successful performance is their ability to carry out in-flight self-calibration of the system obtained for every acquisition mission.

While theoretically it is possible to self-calibrate any optical system turning it into a proper mapping device, in reality, guaranteeing it for each and entire imaging mission is not that simple. That is since a successful in-flight calibration strongly depends on the embedded navigation technology, acquisition profile (platform maneuvering, viewing angles), and atmospheric conditions as well as on the landscape spectral characteristics. All these make the definition of a clear and unique geometric standard for such systems (in analogy to their analog counterparts) pretty challenging.

For the moment, most present and widely internationally and nationally accepted validation solutions are based on dedicated test-fields over which the camera must be flown prior and/or following every imaging mission. These test fields are populated with the so called validation targets physically corresponding to natural or man-made features whose 3D coordinates in object space are known and that can further be precisely identified on the image. These 3D features are projected into the image plane using the geo-referencing transformation (Ground->Image function) and compared with the actual location of that target on the image. The discrepancies in two orthogonal direction on the image are recorded and being used as accuracy indicators for these targets. The accuracies of image locations not associated with those targets are usually obtained by interpolation methods.

There are several shortfalls associated with the abovementioned validation procedure. One obvious disadvantage even beyond the costs involved in setting up and maintaining the test field and having to pass over it on every mission, is the fact that the validation process is spatially limited to the area of the test field and only those images taken on top of the test field can be examined. This limitation is even more dominant for systems with optical & mechanical components not originally designed to maintain an ultimate stability over time and in a variety of environmental conditions (temperature, pressure, etc). Hence a continuous monitoring of their internal parameters is required during the entire mission and not only over the test/calibration field. Also such a monitoring is essential for systems lacking an inherent physical attitude sensor (IMU) and utilizing computer vision techniques (whose success cannot be always guaranteed) for their angular navigation.

One of the most important findings of the recent EuroSDR (European Spatial Data Research Network) Camera Calibration Network is that the entire data-processing chain for digital systems, not just the camera, affects the quality of final results, and this requires identification and implementation of new methods. We claim that for small and medium systems that statement is even more relevant as the mechanical and optical stability of this type of systems, unlike their high-end counterparts (being subject to stringent accuracy quality control during their development and maintenance), is often maintained throughout self-calibration in-mission techniques known to be sensitive to the abovementioned factors.

Our invention deals with introduction of a new measure for geometric accuracy recording of a geo-referenced optical image (stills and video) and further proposes an assessment/validation method for computing this measure. In our proposed solution a dedicated target field for testing the resulting products is NOT required and almost every single image of the mission can be examined. Further, 3D target points will not be required and in essence our method is fully invariant to the 3D structure of the object space captured in the image.

The fundamental idea in this invention is to set the check/validation point right after the triangulation phase where the external orientation of the image of interest is finalized—that is primarily due to the fact that in most modern digital mapping systems the triangulation process cannot be really separated (as far as the external orientation is concerned) from the image acquisition phase in which different navigation aided mechanisms are regularly employed.

While this method is general enough to be applied for any optical imagery (satellite, aerial, terrestrial and even medical), its primarily utilization is prospected for aerial cameras (stills and video) and especially those of medium & small formats and FOVs.

### SUMMARY OF THE INVENTION

The present invention deals with a) Defining a quantitative measure for expressing the geometric accuracy of a single geo-referenced image, and b) A quality control (QC) method for assessing the image accuracy or in other words computing that measure for a given geo-referenced image.

A geo-referenced optical image associates a 3D straight line in object space with every given pixel in the image or put it differently all the points in 3D lying along that straight line will be projected into that single pixel. In our proposed geometric measure we're interested to capture the accuracy of the entire line-of-sight ray originating in the direction of a given pixel and not only of some specific point on the ground/object surface that happens to be the closest to the camera center and actually seen on the image and projected to that pixel. While for a perfectly geo-referenced imagery these two definitions are essentially equivalent, for geo-referenced imagery of finite accuracy (in vantage point location, camera attitude, and the camera model) the former definition is rather more general as it encompasses the whole depth information along the ray as will be demonstrated below. To assess the quality of the entire ray we may therefore wish to compare it with some reference ray extending in the same direction in space.

For two line-of-sight rays, associated with two different images, to overlap (in the case of a perfect error free match, see FIG. 1), the corresponding images perspective centers must lie on the very same line in space. But since we're dealing with images of two-dimensional FOV, more than one image point is considered and the previous constraint must be tightened even more—to corresponding perspective centers sharing the same location in space. In such, rather theoretical case the line-of-sight rays corresponding to conjugate pixels completely overlap (FIG. 1)—that, irrespective of different (though overlapping) viewing angles of the two images, the FOV of the target image as well as the elevation differences on the ground.

While in practice this strong constraint can rarely (if ever) be realized, we can still use the abovementioned fundamental idea for our validation purposes. Given an operational imaging scenario parameters characterized by the camera type and its parameters (FOV in x and y direction), acquisition parameters (position, altitude, viewing angles) and the underlying morphology of the covered area (primarily, elevation differences) one can come out (see how in the sequel) with an a 3D compact region (centered at the target image camera projection center) from which a potential reference geo-referenced image may be selected. Within that region, the maximum discrepancy (encoded for the entire FOV by the generalized proximity criterion (GPC) measure—see below) between the target and the reference rays due to vantage point shift only is bounded from above by the user defined threshold value, the value usually set within one order of magnitude finer than the sought geo-referencing errors to be reported. This criterion depends on the physical leg between the vantage points of the two images and its direction in space, the FOVs of the images, the (angular) orientation of the target image in space and on the altitude variations within the covered are of the target image.

We now generalize the previous discussion on accuracy assessment to comparing more than just one ray. That is realized by comparing the external orientation (geo-referencing) of the image of interest with that of another geo-referenced image the external orientation accuracy of which is assumed to be known and error-free. More specifically, that means comparing (in the way to be described in the following) a set of N corresponding pairs of line-of-sight rays associated with conjugate pixels in the target and reference images respectively, a procedure yielding the discrepancy results encoded in the Spatial Accuracy of Geo-referenced Image (SAGI) measure.

An additional merit of this invention is its provision to robustly support autonomous validation (certification) procedures based on image matching techniques. Due to its special set-up requirement, utilizing reference images that were taken in close spatial vicinity to the target image (see details in the sequel) many of the typical problems associated with general-scenario image matching algorithms are not faced—allowing robust and accurate correspondences when using standard image matching techniques. The automation of the assessment process becomes more & more significant as the number of images resulting from typical triangulation mission increases. Note that the quantity ratio “in favor” of the small/medium compared to large format systems may reach several order of magnitudes (10 s-fold to 100 s-fold)—a serious factor when considering accuracy assessment/validation of say, tens of thousands images per mission.

To summarizes, the spatial accuracy of a geo-referenced image is expressed by that of its external orientation. That, in turn uniquely defines a line-of-sight ray in space for every pixel in the image. We evaluate the accuracy of the image external orientation by comparing the set of N line-of-sight rays across the image field of view, with a corresponding set of rays resulting from the selected reference geo-referenced image (details to follow).

### BRIEF DESCRIPTION OF THE DRAWINGS

For the purpose of illustrating the invention, there is shown in the drawings an embodiment which is presently preferred; it being understood, however, that the invention is not limited to the precise arrangements shown.

FIG. 1 depicts the fundamental fact driving the invention—Two images with common perspective center yield identical line-of-sight rays when represented in a common object space coordinate frame.

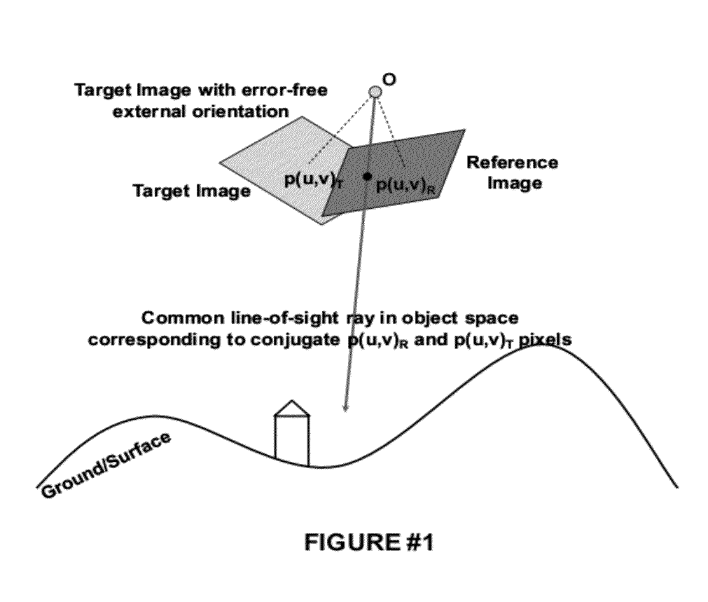

FIG. 2 shows that for a slightly erroneous external orientation of the image to be examined, different line-of-sight rays in space result for conjugate pixels on the two images.

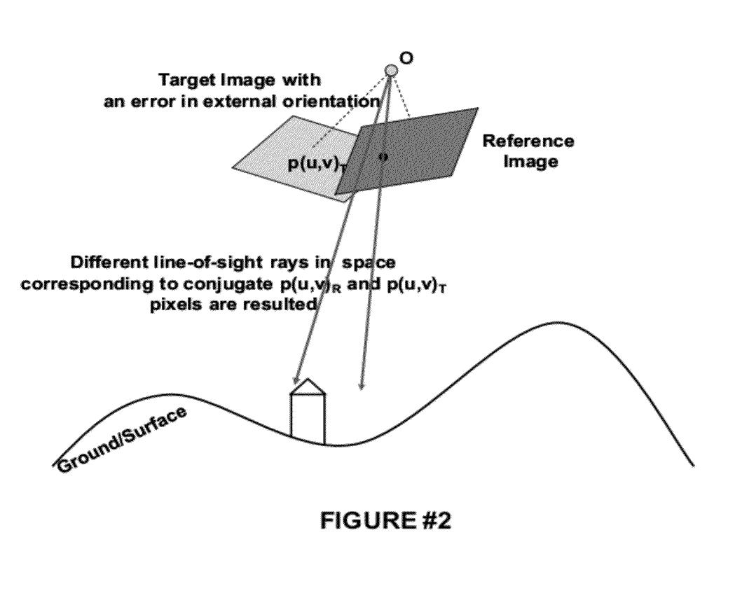

FIG. 3 demonstrates the effect of displacing the perspective center of the reference image on the spatial dissimilarity between the line-of-sight rays corresponding to a pair of conjugate pixels.

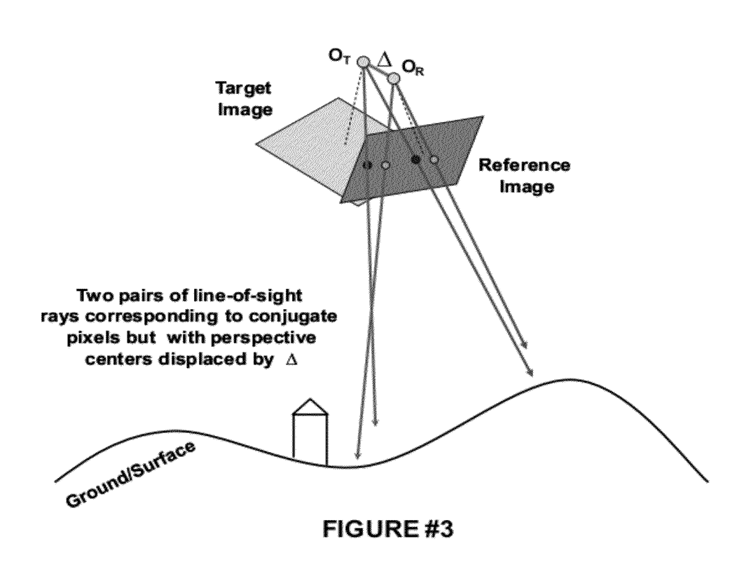

FIG. 4 shows how the spatial dissimilarity between the rays is analytically determined. As the dissimilarity changes along the ray we limit the computation to the 3D region bounded between the covered area minimum and maximum elevations, where the ground objects of interest are essentially present.

FIG. 5 illustrates the computation of the 3D region for selecting potential reference images according to GPC factor (see 2.II). Green clusters on the image correspond to VALID sectors where the dissimilarity resulting from the spatial lag between the two camera centers falls below a predefined misalignment threshold as defined in subsection 2.I below.

### DETAILED DESCRIPTION OF THE ASSESSMENT METHOD

1. Terminology and Notations

A geo-referenced optical image is a Line-Of-Sight measurement device. It associates a 3D straight line in object space with every given pixel p(u,v) in that image. From geometric point of view that means that this 3D line is the geometric place of all points in space which project into p(u,v). Analytically speaking, a geo-referenced image is assigned with the so-called external orientation information which in turn can be represented either explicitly or implicitly. In the explicit representation (also entitled as rigorous photogrammetric model) the line-of-sight originating from pixel p(u,v) can be easily computed from the external orientation parameters (decomposed into interior and exterior orientation) to result with the parametric 3D line in space represented parametrically by [X(τ) Y(τ) Z(τ)]^{T}=[X_{C} Y_{C} Z_{C}]^{T}+[uₓ u_{y} u_{z}]^{T}τ where [X_{C} Y_{C} Z_{C}]^{T} is the 3D camera position in space at the time of the exposure and [uₓ u_{y} u_{z}]^{T} is a unit direction along the 3D line direction (dependent on p(u,v), interior (focal length, principal point, lens distortions, etc) and exterior (rotation matrix) parameters—which, as the name suggests, are explicitly available. In the implicit form the external orientation is given by the functional form

u=f(X,Y,Z); v=g(X,Y,Z) (1)

where f & g are differentiable functions from 3D object space into row and column pixel coordinates u and v respectfully. Here, given a pixel p(u,v), the straight line parameters cannot be directly computed from u and v. What is proposed is an iterative procedure to be described now. Recall, that to uniquely define a straight line in space a point on that line and its direction must be determined. Without loss of generality we thereby select a point with some fixed elevation Z=Z₀. Now, substituting this value into (1) gives

u=f(X,Y,Z₀); v=g(X,Y,Z₀) (2)

two (in general) non-linear equations in X,Y (the horizontal point coordinates). The coordinates X and Y satisfying (2) are now computed iteratively as follows:
(a) Start with initial guess for X,Y, say (Xᵢ,Yᵢ).
(b) Develop (2) into a first order Tailor series around (X,Y)=(Xᵢ,Yᵢ).

$$( c ) u = f ( {X}_{i} , {Y}_{i} , {Z}_{0} ) + \frac{δ f}{\partial x} d X + \frac{δ f}{\partial y} d Y$$

$$v = g ( {X}_{i} , {Y}_{i} , {Z}_{0} ) + \frac{δ g}{\partial x} d X + \frac{δ g}{\partial y} d Y$$

(d) Use (c) (two linear equations with 2 unknowns) to solve for dX and dY.
(e) Update the approximation for X and Y by (Xᵢ,Yᵢ)=(Xᵢ,Yᵢ)+(dX,dY).
(f) If dX and dY are smaller than a predefined threshold set (X₀,Y₀)=(Xᵢ,Yᵢ) and stop else go back to (b).

Now we turn to determine the direction of the 3D straight line originating at p(u,v) passing through point (X₀,Y₀,Z₀) and satisfying (1). Again we develop (1) into a first order Tailor series, now around (X₀,Y₀,Z₀) to yield

$$\begin{matrix}u = f ( {X}_{0} , {Y}_{0} , {Z}_{0} ) + \frac{δ f}{\partial X} d X + \frac{δ f}{\partial Y} d Y + \frac{δ f}{\partial Z} d Z & ( 4 ) \\ v = g ( {X}_{0} , {Y}_{0} , {Z}_{0} ) + \frac{δ g}{\partial X} d X + \frac{δ g}{\partial Y} d Y + \frac{δ g}{\partial Z} d Z & \end{matrix}$$

But (X₀,Y₀,Z₀) satisfying (1), namely u=f(X₀,Y₀,Z₀); v=g(X₀,Y₀,Z₀), hence

$$\begin{matrix}0 = \frac{δ f}{\partial X} d X + \frac{δ f}{\partial Y} d Y + \frac{δ f}{\partial Z} d Z & ( 5 ) \\ 0 = \frac{δ g}{\partial X} d X + \frac{δ g}{\partial Y} d Y + \frac{δ g}{\partial Z} d Z & \end{matrix}$$

Finally, from (5) the 3D line direction (dX,dY,dZ) orthogonal to both

$$( \frac{δ f}{\partial X} , \frac{δ f}{\partial Y} . \frac{δ f}{\partial Z} ) and ( \frac{δ g}{\partial X} , \frac{δ g}{\partial Y} , \frac{δ g}{\partial Z} ) ,$$

thus it is parallel to their vector product, namely

$$( α , β , γ ) = ( \frac{δ f}{\partial X} , \frac{δ f}{\partial Y} . \frac{δ f}{\partial Z} ) \times ( \frac{δ g}{\partial X} , \frac{δ g}{\partial Y} , \frac{δ g}{\partial Z} ) .$$

The 3D straight line parametric representation for implicit external orientation is thus given by:

[X(τ)Y(τ)Z(τ)]^{T}=[X₀Y₀Z₀]^{T}+[αβγ]^{T}τ

2. Detailed Description of the Accuracy Assessment Algorithm

We now turn to describe a sequence of steps for carrying out the sought analysis. Details on each step (including graphical elaborations) will be provided in dedicated subsections to follow.
(a) Get the 3D camera position of the target image (to be denoted by TrgImg). Use either mission planning system, navigation (GPS/INS) aiding telemetry or compute it from several line-of-sight ray backward intersections available from implicitly provided external orientation (Maximizing the bounding area of the corresponding (to line-of-sight rays) pixels in the image).
(b) Set elevation bounds (MinElv and MaxElv) for the imaged area.
(c) Use (a) and (b) along with the predefined threshold values for line-of-sight misalignments (LOSiM) (see details in subsections 2.I, 2.II below) to compute the 3D region from which the reference image is to be selected. Select the set {s} of all the potential images whose camera position falls in that region (see details in subsection 2.II below).
(d) Among {s}, choose the reference image (to be denoted by RefImg) as the one with the minimal generalized proximity criterion (GPC) (see 2.II).
(e) Select N conjugate point pairs (covering the entire TrgImg FOV) on TrgImg and RefImg and compute the corresponding line-of-sight rays.
(t) Determine the spatial misalignment between the corresponding N line-of-sight rays (see subsection I below for details).
(g) Compute and report the spatial accuracy for TrgImg (see subsection 2.III below for details).

It is worth mentioning that although the present invention has been described in relation to particular embodiments thereof, many other variations and modifications and other uses will become apparent to those skilled in the art, without departing from the spirit and scope of the invention.

### 2.I. Line-of-Sight Rays Misalignment (LOSiM) Computation

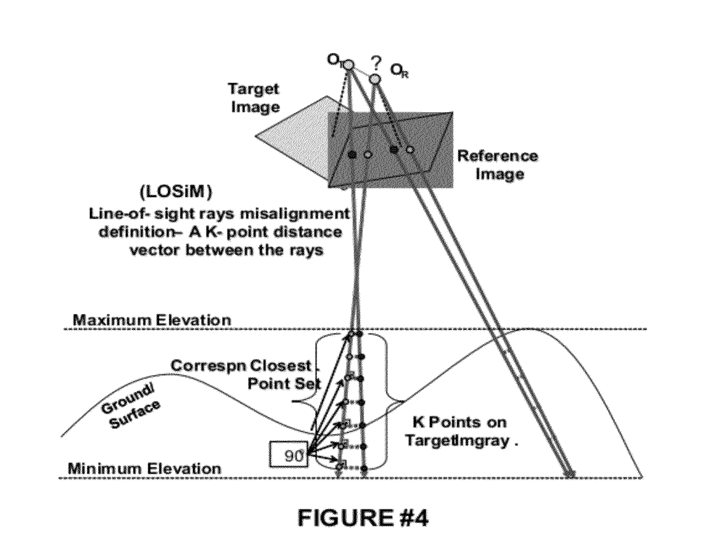

Given parametric representation of a pair of corresponding line-of-sight rays Γ_{Tr}(τ)=[X(τ) Y(τ) Z(τ)]^{T}=[X_{C} Y_{C} Z_{c}]_{Tr}^{T}+[u_{X} u_{Y} u_{Z}]_{Tr}^{T}τ and Γ_{Rf}(ν)=[X(ν) Y(ν) Z(ν)]^{T}=[X_{C} Y_{C} Z_{C}]_{Rf}^{T}+[u_{X} u_{Y} u_{Z}]_{Rf}^{T}ν emanating from TrgImg and RefImg respectively, we define a (K,2) misalignment matrix Ψ, where K denotes the number of points along the (bounded) Γ_{Tr} ray (see FIG. 4) where the misalignment is computed. The two i's (i=1,K) row elements of Ψ contain a two dimensional misalignment vector [ψ₁ ψ₂] for point i, being perpendicular to line-of-sight direction. For example, in the case of a perfectly vertical imagery the indexes 1 and 2 of the misalignment vector may correspond to ground horizontal axes X and Y respectively (or any rotation of those about Z). In this case the K line parameters τⱼ, j=0,K−1, that would equally partition the bounded line segment are given by:

$${τ}_{j} = τ ( Min Elv ) + \frac{Max Elv - Min Elv}{K} j ,$$

j=0,K−1 and with

$$τ ( Min Elv ) = {τ}_{0} = \frac{Min Elv - {( {Z}_{c} )}_{Tr}}{{( {u}_{Z} )}_{Tr}} ,$$

TrgImg line parameter corresponding to the minimum elevation value MinElv.

Now, for every point Γ_{Tr}(τⱼ), the closest point Γ_{Rf}(νⱼ) on Γ_{Rf}(ν) to Γ_{Tr}(τⱼ) (to be found by orthogonal projection) is computed (see FIG. 4). Finally, the X & Y components of the vector connecting Γ_{Tr}(τⱼ) and Γ_{Rf}(νⱼ) are computed and saved in the j^{th} row of Ψ.

### 2.II. Defining the 3D Region for Reference Image Selection

A compact 3D region Ω⊂R³ is constructed in such a way that every PεΩ, if assigned as the perspective center of RefImg would cause to none of the misalignment matrix Ψ elements to exceed (in absolute value) a predefined threshold, say [ψ_{X}^{THR} ψ_{Y}^{THR}]. Further, that condition should hold for all line-of-sight rays of TrgImg.

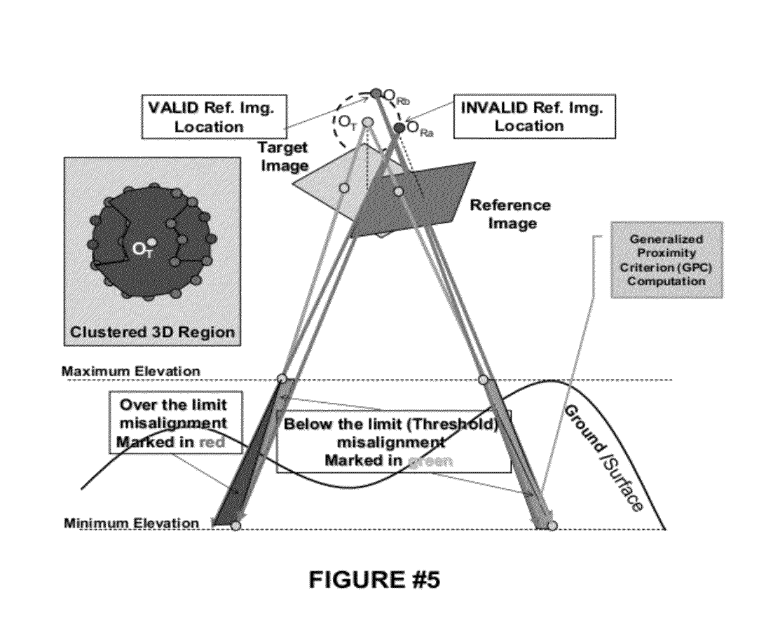

The construction of Ω follows the steps below (also see FIG. 5):
(a) Homogeneously tessellate the field-of-view (FOV) of TrgImg to come out with a mesh of pixels {p}_{i,j}.
(b) For every pixel in {p}_{i,j} compute the respective line-of-sight ray Γ_{Tr}^{p(i,j)}. Intersect this ray with two horizontal surfaces—one at elevation MinElv and the other at MaxElv. Two 3D points result from the intersection, P_{Mn} and P_{Mx}.
(c) Explore the 3D region around the camera center of TrgImg by generating concentric spherical surfaces with equally-spaced increasing diameters. Sample every surface homogeneously in elevation & azimuth angles to yield a set of 3D points Q. For every point qεQ and for every {p}_{i,j} do
   [1] Assign q as the perspective center of RefImg.
   [2] Compute two line-of-sight vectors q->P_{Mn} and q->P_{Mx}
   [3] Compute the misalignment matrix between Γ_{Tr}^{p(i,j)} and each of the two rays in [2] (See details in subsection 2.I above)
   [4] If none of the misalignment matrix Ψ elements exceeds the predefined [ψ_{X}^{THR} ψ_{Y}^{THR}] thresholds move to next pixel in the mesh.
   [5] Let the Generalized Proximity Criterion (GPC) for qεQ be defined as the maximum (2D) norm among all entries of Ψ for all mesh pixels {p}_{i,j}.
   [6] If GPC of qεQ is below the norm of [ψ_{X}^{THR} ψ_{Y}^{THR}] set point qεQ as VALID.
      i. Else set point qεQ as INVALID
(d) Cluster the VALID points in {q} into the sought 3D region Ω.

### 2.III. Spatial (Geometric) Accuracy of a Geo-Referenced Image (SAGI)

The spatial accuracy across a geo-reference image changes (in general) for different image locations. Nor is it fixed all the way along a single ray, since, as shown in FIG. 4, different points along the ray may give rise to different misalignment vectors. We choose to represent the spatial accuracy of an image in two directions orthogonal to the optical axis vector of the image. Without loss of generality let X′ & Y′ be these two directions. (For nearly vertical image these directions nearly coincide with the X & Y components of the object frame in 3D; for terrestrial and oblique imagery a different basis for spanning the sub-space may be required). Each of the components is a scalar field in 3D. More formally, let ErrX′:Ω⊂R³→R, ErrY′:Ω⊂R³→R the two “heat” maps in Ω. For every pεΩ, these two function define the 2D spatial error vector that corresponds to p. Note again that this vector is also a function of Z. These maps are populated by homogeneously sampling the N line-of-sight rays in a similar fashion to the one described in line-of-sight misalignment computations (subsection 2.I). Finally, common 3D interpolation techniques are used to generate a regular 3D mesh, if required.

What is claimed is:

1. A definition of a quantitative measure for Spatial (geometric) Accuracy of a Geo-referenced Image (SAGI) captured with optical (stills, video) sensor and represented in either rigorous or implicit (e.g., rational polynomial functions (RPC)) form.

2. The SAGI measure according to claim 1, further represented by two 3D accuracy maps corresponding respectively with two orthogonal directions lying in the plane perpendicular to the image optical axis; The two 3D accuracy maps are resulted from Line-of-sight ray misalignment (LOSiM) computation applied on a mesh of pixels on the image, covering its field of view (FOV).

3. The definition according to claim 1, further enabling to clearly distinguish between the merit of the process of triangulation resulting in geo-referenced imagery and the quality of subsequent phases in GeoInformation (GI) production (e.g., Ortho, Surface Reconstruction, Mosaicking) being dependent on external information and potential image matching errors—an important property of any QA process.

4. A method for assessing the SAGI measure, according to claim 1, further uses an appropriately selected reference image from an existing geo-referenced image database.

5. The selection according to claim 4, further done by employing the Generalized Proximity Criterion (GPC).

6. The GPC criterion according to claim 5, depending on the physical leg between the vantage points of the two images, the leg direction in space, the FOVs of target image as well as its (angular) orientation as well as on the altitude/elevation variations of the imaged area.

7. A method according to claim 4, realizing the assessment by comparing a set of N corresponding pairs of line-of-sight rays associated with conjugate pixels in the target and reference images respectively, and covering the target image FOV.

8. The method according to claim 4, wherein the GPC selection criterion is applied, being invariant to the underlying structure of the relief and the surface covered by the image.

9. The method according to claim 4, further supporting both explicit (rigorous) and implicit (e.g., rational polynomial functions) geo-referencing.

10. The method according to claim 4, supporting any type of optical imagery, regardless of its acquisition geometry (stills, push-broom, etc).

11. SAGI definition according to claim 1 and its implementation according to claim 5, do not require dedicated validation fields nor 3D control points for the assessment process.

12. The method according to claim 4, not necessitating the use of sophisticated image matching techniques for autonomous validation; standard matching techniques can be successfully used to result with robust and accurate validation outcomes.
